(19) United States
(12) Patent Application Publication
(10) Pub. No.: US 2026/0168917 A1
(43) Pub. Date: Jun. 18, 2026

(54) Apparatus and method for measuring optical properties, in particular color measuring device

(71) Applicant: BYK-Gardner GmbH, Geretsried (DE)

(72) Inventors: Jozef HOPKO, Geretsried (DE); Kilian SAPPL, Bad Tölz (DE); Uwe SPERLING, Geretsried (DE); Stefan KIRNER, Königsdorf (DE)

(21) Appl. No.: 19/124,013

(22) PCT Filed: Sep. 28, 2023
(86) PCT No.: PCT/EP2023/076879

§ 371 Date: Apr. 24, 2025

(30) Foreign Application Priority Data
Oct. 24, 2022 (DE) 10 2022 128 033.0

(51) Int. Cl. G01N 21/25; G01N 21/47

(52) U.S. Cl. CPC G01N 21/251; G01N 21/4738; G01N 2201/127

(57) ABSTRACT

An apparatus for examining optical properties of surfaces, includes a first calibration element which, instead of the surface to be examined, is arranged such a way that radiation which has been emitted from the first radiation device onto the first calibration element and has been reflected and/or scattered by the first calibration element reaches the first radiation detector device. The apparatus has a second calibration element which instead of the surface to be examined and instead of the first calibration element, is arranged such that radiation which has been emitted from the first radiation device onto the second calibration element and has been reflected and/or scattered by the second calibration element reaches the first radiation detector device.

### BACKGROUND OF THE INVENTION

The present invention relates to an apparatus and a method for measuring optical properties and, in particular, for determining optical properties of surfaces. In particular, the apparatus is described with reference to a color measuring device, but it is pointed out that the invention is also suitable for other devices for measuring or determining optical properties (of surfaces) such as a gloss or the like.

A calibration standard, hereinafter referred to as a calibration element, is often used in color measuring devices in order to be able to detect and intercept and/or correct possible ageing, for example a decrease in the intensity of light waves. It is known that this correction is implemented using a calibration factor, which ensures that color measurement values (in the laboratory system, in particular the L value) always remain the same for an identical sample, regardless of the quality of the lighting.

However, it has been shown that such measurements are often influenced by, for example, dirty calibration elements. For example, a dirty or damaged calibration element can simulate the ageing of a light source that does not exist in reality and thus worsen a measurement such as a color measurement via an incorrectly set calibration factor.

The present invention is therefore based on the task of achieving a more accurate calibration of such apparatuses and, in particular, of eliminating and/or taking into account various sources of error which could influence the calibration.

### SUMMARY OF THE INVENTION

An apparatus according to the invention for examining the optical properties of surfaces has a housing and a first radiation device arranged within the housing, which is suitable and intended for emitting radiation and in particular light and in particular light in the visible wavelength range, for example light in a wavelength range of 300 nm-700 nm, onto a surface to be examined.

Furthermore, the apparatus has a first radiation detector device arranged inside the housing, which is suitable and intended to receive radiation irradiated onto the surface to be examined and radiation reflected and/or scattered by the surface. Furthermore, the housing has an opening through which the first radiation device emits radiation onto the surface to be examined.

Furthermore, the apparatus has a first calibration element which, instead of the surface to be examined, can be arranged in such a way that radiation which has been emitted from the first radiation device onto the first calibration element and has been reflected and/or scattered by the first calibration element reaches the first radiation detector device.

According to the invention, the apparatus has a second calibration element which instead of the surface to be examined and instead of the first calibration element, can be arranged in such a way that radiation which has been emitted from the first radiation device onto the second calibration element and has been reflected and/or scattered by the second calibration element reaches the first radiation detector device.

It is therefore proposed that two calibration elements or two calibration standards are used independently of each other in order to perform the calibration as a whole. In this way, it is possible to eliminate certain errors resulting from a faulty calibration element or to make this recognisable.

Preferably, the first and/or second calibration element has a white surface on the surface facing the radiation device. It is particularly preferable for this to be a predetermined white standard, which preferably also has a gloss level suitable for gloss calibration in addition to the property “white”.

For example, the surface of the calibration element can be made of ceramic. Other materials that are stable and/or color-stable and preferably also resistant to ageing can also be used.

In a preferred embodiment, the calibration element is arranged on a holder. Particularly preferably, the first and/or calibration element is always or permanently arranged within the housing. However, it would also be conceivable for the first and/or second calibration element to be arranged outside the housing, for example on a (particularly swiveling) support arm.

Preferably, the first and/or second calibration element can be moved and in particular swiveled in the beam path between the radiation device and the detector device. Particularly preferably, the calibration element is arranged in a holder. Particularly preferably, this holder is designed to absorb light and/or is made of a light-absorbing material.

In a preferred embodiment, the first and/or second calibration element can be arranged in such a way that a surface exposed to the radiation device coincides with the surface to be examined or is parallel to it. For example, the first calibration element within the housing can be swiveled into a position in which its surface is parallel to the surface of a surface used or to be examined during operation.

Preferably, the second calibration element can be placed on the opening and is thus preferably located at the position where the surface to be analysed is located in a measuring mode.

In a preferred embodiment, the apparatus has a closing device and in particular a shutter cleaning device, which is suitable and intended to close the opening in certain periods, in particular in periods in which no measurement takes place or the apparatus is switched off. In this way, contamination can be prevented from entering the apparatus or the housing outside of operation.

In a further preferred embodiment, the radiation detector device is suitable and intended for recording spatially resolved images of the surface to be examined.

In a further embodiment, the radiation detector device is suitable and intended to measure a radiation intensity impinging on it.

In a further preferred embodiment, the radiation detector device is suitable and intended to perform a wavelength resolution of the radiation impinging on it. In other words, the radiation detector device allows the radiation incident on it to be analysed with regard to its wavelength and/or outputs wavelength-dependent measurement results.

Particularly preferably, the radiation detector device allows a wavelength-dependent analysis of the radiation impinging on it, especially in a visible wavelength range.

The radiation detector device is particularly preferably a spectrometer device.

Particularly preferably, the apparatus has a holding device or a holding volume for holding one of the calibration elements. Particularly preferably, the apparatus has a holding compartment or a holding volume for both calibration elements. Preferably, the two calibration elements are stored separately from each other.

In a further preferred embodiment, the two calibration elements are stored in different orientations, in particular in different orientations with respect to an orientation of the abovementioned opening through which the surface to be examined is illuminated in a working mode. In this way, a space-saving arrangement can be created.

Particularly preferably, the second calibration element can be removed from the receiving volume and placed on the opening of the apparatus, for example, in order to carry out a calibration measurement.

In a particularly preferred embodiment, the inner surface of the housing is light-absorbing, for example black.

In a further advantageous embodiment, the apparatus has a processor device which determines a measured value and in particular a calibration value from a value output by the radiation detector device. Particularly preferably, the processor device can use a calibration value for this purpose. Particularly preferably, the calibration value is stored or can be stored in a memory device of the apparatus. Particularly preferably, this calibration value can be changed and, in particular, can be changed as the result of a calibration measurement.

Particularly preferably, one of the calibration elements can be arranged within the housing and preferably be movable within the housing in a beam path between the first radiation device and the first radiation detector device. Particularly preferably, this one calibration element can be placed against the opening from the inside.

In a further advantageous embodiment, the apparatus has a processor device which detects a first value characteristic of a first calibration measurement with the first calibration element and which detects a second value characteristic of a second calibration measurement with the second calibration element, and preferably the apparatus has a comparison device which compares the first value and the second value with one another.

Particularly preferably, the comparison between the first value and the second value can be used to draw conclusions about a fault condition of the apparatus and/or the calibration elements. It is particularly preferred that the first and second values are comparative values. In a preferred embodiment, this comparison can be used to infer a cause of error in the context of a calibration measurement.

In a further preferred embodiment, the apparatus has an output and/or display device which is suitable and intended to output at least one signal which is characteristic of a specific error. For example, the display can indicate that one of the calibration elements is dirty or that the calibration element is not properly positioned.

The display device is particularly preferably a display, which is particularly preferably integrated into the housing of the apparatus. The display is particularly preferably suitable and intended for alphanumeric output of information.

In order to be able to recognise beyond doubt, for example, that a calibration factor may rightly be changed by a white standard calibration, it is proposed that several recorded measured variables are related to each other and a clear statement about the condition of the apparatus and, for example, the spectrophotometer and/or the calibration element is derived from this.

It is proposed here that two calibration elements are used. Preferably, this is an external calibration element, which is placed on the measuring opening like a sample to be measured, and preferably an internal calibration element, which is integrated into a sealing cap, which preferably closes the measuring opening in a motorised manner when no measurement is being taken.

Particularly preferably, at least one calibration element is integrated into a closing device which is intended for closing the opening through which the surface to be examined is illuminated in a working mode.

It is particularly preferable to determine the calibration factor separately for both calibration elements.

Preferably, the apparatus is selected from a group of devices which includes color measuring devices, gloss measuring devices, orange-peel measuring devices and the like. The apparatus is particularly preferably a color measuring device.

Particularly preferably, the apparatus has a second radiation device arranged within the housing, which is suitable and intended to emit radiation and in particular light onto the surface to be examined.

Particularly preferably, this radiation or the reflected and/or scattered radiation resulting from this radiation (from the surface to be examined) is also detected by the detector device described above.

Particularly preferably, the second radiation device is arranged in such a way that it irradiates radiation onto the surface at a different angle than the first radiation device mentioned above. For example, it is possible that a first radiation device emits radiation at an angle of, for example, 60° or 45° relative to the surface and a second radiation device emits radiation at an angle of 20° relative to the surface.

Preferably, at least one radiation device emits radiation onto the surface at an angle relative to the surface that is between 30° and 60°, preferably between 40° and 50°. Preferably, at least one radiation device emits radiation onto the surface at an angle relative to the surface that is between 10° and 30°, preferably between 15° and 25°.

Preferably, these radiations can also be irradiated onto or directed to the detector device by means of the calibration element.

In a further advantageous embodiment, the apparatus also has a second detection device, or a second radiation detector device, which detects the radiation impinging on it. In particular, this second detector device can be arranged at a different angle to the surface than the first radiation deflection device described above.

Particularly preferably, the apparatus has a plurality of radiation devices, each of which is suitable and intended to irradiate light onto the surface to be examined. This may, for example, be a plurality of light sources, which particularly preferably partially emit white light and particularly preferably at least partially emit light of different colors and/or wavelengths.

The radiation devices can have a variety of radiation characteristics such as directional lighting, lighting within a predetermined angle acceptance or diffuse lighting.

It is particularly preferable for this plurality of radiation devices to be arranged along a circular line. Particularly preferably, this circular line runs parallel to the surface to be analysed.

Particularly preferably, the radiation detector device is arranged such that it is substantially perpendicular above the surface to be examined, and in particular a direction from which it picks up radiation from the surface is substantially perpendicular to the surface.

Particularly preferably, the apparatus also has a gloss measuring device (and/or reflection measuring device). This gloss measuring device and in particular a radiation device of this gloss measuring device preferably emits light onto the surface at a predetermined angle and a detector device detects light from the corresponding reflection angle.

This gloss measuring device can also be used to evaluate the calibration. If the apparatus is operated in the orientation with the measuring aperture facing upwards, the optics may become contaminated in a very dusty environment despite the measuring aperture being closed, for example by a shutter. However, small gloss angles, for example 20°, are much more affected by this than large angles such as 60°.

If only one gloss angle is measured, the gloss value of the first calibration element can be related to the gloss value of the second calibration element in relation to the calibration factors. As shown in more detail below, different conclusions can be drawn from a suitable combination of observations.

If, for example, the 20° gloss of an internal calibration element deviates significantly more from a calibrated original gloss value, but the 60° gloss is almost unchanged, this indicates that the optical elements are contaminated.

In a further advantageous embodiment, the apparatus has a gloss measuring device, wherein this gloss measuring device has a further radiation device which irradiates radiation onto the surface at a predetermined angle of incidence and the gloss measuring device also has a further radiation detector device which detects radiation irradiated onto the surface by the further radiation device and reflected from the surface at a predetermined angle, wherein the angle of incidence and the further angle are preferably the same.

The present invention is further directed to a method for examining optical properties and in particular color properties of surfaces, wherein a radiation device arranged within a housing emits radiation and in particular light onto a surface to be examined and a first radiation detector device arranged within the housing receives the radiation irradiated onto the surface to be examined and reflected and/or scattered by the surface (and/or this radiation strikes the radiation detector device), wherein the housing has an opening through which the first radiation device emits radiation onto the surface, and wherein the apparatus has a first calibration element which is arranged in a calibration mode in place of the surface to be examined in such a way that radiation which is emitted by the first radiation device onto the first calibration element and is reflected and/or scattered by the first calibration element reaches the first radiation detector device.

According to the invention, a second calibration element is arranged in the calibration mode instead of the surface to be examined and instead of the first calibration element in such a way that radiation emitted by the first radiation device onto the second calibration element and reflected and/or scattered by the second calibration element reaches the first radiation detector device.

It is therefore also suggested that different measurements, and in particular at least two measurements with different calibration elements, are carried out. These different measurements can be used to draw conclusions about different sources of error.

Preferably, a calibration factor is changed on the basis of at least one calibration measurement performed. In particular, this calibration factor is changed if the calibration measurements show that deviations in the measurements are due to a modification of the optical properties of the radiation device. In particular, the calibration factor is changed in order to take into account and/or compensate for an ageing state of at least one radiation device.

A first value characteristic of a first calibration measurement with the first calibration element and a second value characteristic of a second calibration measurement with the second calibration element are recorded with particular preference.

Particularly preferably, the first value and the second value are compared with each other and, particularly preferably, an instruction or information about an error is issued to a user taking this comparison into account.

Preferably, the first and second values are set in a mathematical relationship to each other. It is therefore possible to form a difference between the first value and the second value. However, it would also be possible for a quotient to be formed between the first and the second value. It is particularly preferable to form both a difference between the first and second values and a quotient between the first and second values. For example, it can be determined which of the two values is greater. This can be used to draw conclusions about possible error states of the apparatus and/or the calibration elements. Furthermore, the ratio can be used to determine whether the two values are approximately the same or differ significantly from each other.

In another preferred method, a further measured value, in particular a measured gloss value (in particular at a specified angle of incidence), is also determined. The gloss measurement is preferably carried out in so-called gloss units as described in detail in the current standards (for example ISO 2813 or ASTM D 253). Preferably, this measured gloss value is compared with a predetermined value, for example an initial value.

It can be determined whether the measured value is approximately equal to the initial value or deviates from it and, in particular, is smaller. This gloss value measurement can be used for both the first calibration element and the second calibration element.

It is particularly preferable to take into account several of the values or analyses determined above in order to draw conclusions about a fault condition of the apparatus or also of the calibration elements or also of the optical devices. The following table shows a corresponding list of different error sources.

It is particularly preferable to differentiate between different sources of error depending on the above comparison.

It is particularly preferable to change a calibration value taking into account at least one of the measured values. This can be seen in particular in the table above.

| Possible case | 1 | 2 | 3 | 4 |
|---|---|---|---|---|
| Calibration factor internal | ca_i > 1 | ca_i > 1 | ca_i ≈ 1 | ca i ≈ 1 |
| standard or first calibration | | | | |
| element (ca_i) | | | | |
| Calibration factor external | ca_e > 1 | ca_e > 1 | ca_e > 1 | ca_e ≈ 1 |
| standard or second calibration | | | | |
| element (ca_e) | | | | |
| Ratio of internal to external | ca_i/ca_e ≈ 1 | ca_i/ca_e ≈ 1 | ca_i/ca_e < 1 | ca_i/ca_e ≈ 1 |
| calibration factors | | | | |
| Gloss measurement value 20° | gi < gloss_i0 | gi ≈ gloss_i0 | gi ≈ gloss_i0 | gi ≈ gloss_i0 |
| internal standard or first | | | | |
| calibration element gi in | | | | |
| relation to the initial value | | | | |
| gloss_i0 | | | | |
| Gloss measured value 20° | ge < gloss_e0 | ge ≈ gloss_e0 | ge < gloss_e0 | ge < gloss_e0 |
| external Std ge in relation | | | | |
| to initial value gloss_e0 | | | | |
| Optional - Viewing the | | | | |
| 60° gloss | | | | |
| Problem - Diagnosis | Dirty optics | Light source of | External | External |
| | | the color | standard | standard |
| | | measurement aged | soiled | tilted mounted |
| Action - Indication in the | Clean the optics | Reset calibration | Clean | Check the correct |
| display | inside the device, | factor | external | position of the |
| | leave the calibration | | standard | external standard |
| | factor unchanged | | | during installation |

The table above shows four cases of errors or states. These are labelled with the numbers 1-4 in the top line.

The second line shows possible measurement results for the calibration factor ca_i for the first calibration element (in particular the calibration element located inside the housing during the calibration measurement). This can either be greater than 1 (which indicates an error state) or approximately equal to 1 (which indicates a target state).

The third line shows possible measurement results for the calibration factor ca_a for the second calibration element (in particular the calibration element located outside the housing during the calibration measurement). This can either be greater than 1 (which indicates an error state) or approximately equal to 1 (which indicates a target state).

The fourth line shows a ratio between the measured calibration factors ca_i and ca_a. If this ratio is approximately 1, i.e. the two calibration factors are approximately equal, this indicates a target state with regard to any contamination of the two calibration elements and in particular of the second calibration element. If this ratio ca_i/ca_a is less than 1, this indicates that the outer calibration element is contaminated (see third column and penultimate row of the table).

In the fifth line, measured gloss values gi (and/or measured reflection values) are determined at an angle of incidence of 20° and with the first calibration element. In the sixth line, measured gloss values ga (and/or measured reflection values) are determined at an angle of incidence of 20° and with the second calibration element.

These determined gloss measurement values are preferably compared with the respective initial measurement values gloss_i0 and gloss_e0. If both values deviate (second column), this is an indication of a dirty optic. If only the value for the second calibration element deviates, this is an indication that it is either dirty or not correctly applied to the opening.

Optionally, gloss measurements can also be carried out at a second angle, such as 60°.

In another preferred method, the surface to be examined is exposed to several radiation devices in a working mode. Preferably, the surface to be examined is exposed to at least two radiation devices. Particularly preferably, these two radiation devices irradiate radiation at at least two different angles. It is particularly preferred that the irradiation with the first radiation device is offset in time to the irradiation with the second radiation device.

In a further preferred embodiment, the radiation detector device detects the radiation impinging on it as a function of wavelength.

The radiation detector device is particularly preferably a spectrometer. Particularly preferably, the radiation detector device outputs a value characteristic of a specific wavelength. Particularly preferably, this value is output both during the measurement with a surface to be analysed and during calibration.

In a further preferred method, at least one calibration (it is noted here that the terms calibration and calibration are used synonymously) is used to determine and take into account an ageing condition of at least one radiation device.

In another preferred method, the surface to be analysed is illuminated with light of different wavelengths and/or with white light.

In another preferred method, the surface to be analysed is irradiated from at least two different angles of incidence.

In another preferred method, at least one color measurement value is always essentially constant for an identical sample, regardless of the quality of the illumination.

### BRIEF DESCRIPTION OF THE DRAWINGS

Further advantages and embodiments are shown in the enclosed drawings.

Show in it:

FIG. 1 a view of an apparatus according to the invention;

FIG. 2 a view of the inside of the apparatus through the measuring openings;

FIG. 3 an interior view of an apparatus according to the invention;

FIG. 4 a further interior view of an apparatus according to the invention;

FIG. 5 a further interior view of an apparatus according to the invention; and

FIG. 6 a further interior view of an apparatus according to the invention.

### DETAILED DESCRIPTION OF THE INVENTION

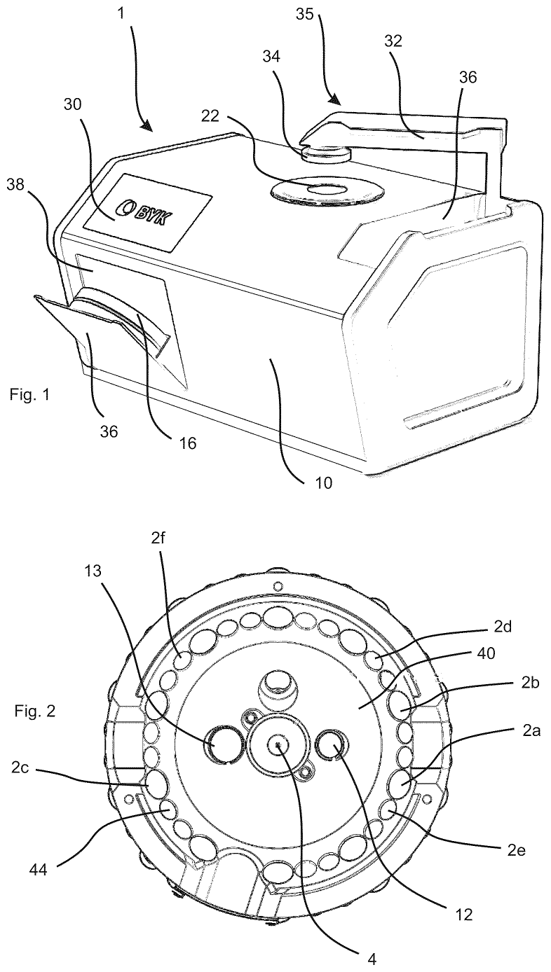

FIG. 1 shows an external view of an apparatus 1 according to the invention for examining optical properties of surfaces. This apparatus 1 has a housing 10. Furthermore, the housing has a receiving opening 38 or a receiving volume for receiving a second calibration element 16 (external calibration element), which in particular serves to store it.

This external calibration element 16 is arranged here on a swiveling flap 36. The reference sign 30 indicates a display device with which, for example, measured values or error states can be displayed. The reference sign 22 indicates an opening through which a surface to be examined (not shown) can be examined with regard to its color and/or with regard to other optical properties such as a gloss value. Preferably, light can only enter the interior of the housing 30 via this opening 22.

In the embodiment shown in FIG. 1, the apparatus has a pressure device 35, which here has a swiveling arm 32 on which a pressure element 34 is arranged for pressing a sample against the opening 22. This pressure device 35 can be retracted or lowered into a recess 36 of the housing. In one embodiment, it would be possible to arrange a first calibration element on the sealing device 35. Preferably, however, the second calibration element is arranged inside the housing 10.

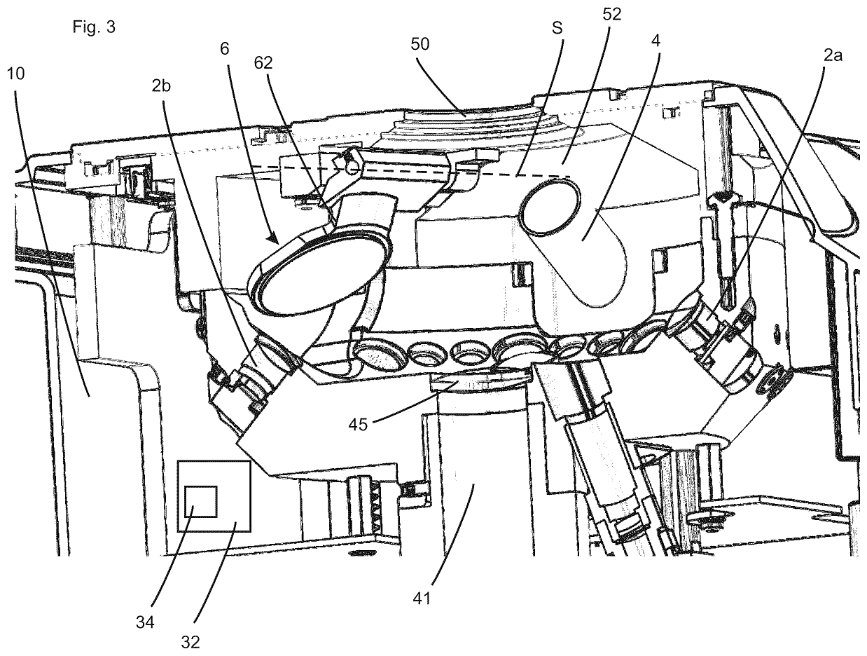

FIG. 2 shows a view into the interior of the housing through the opening 22. In particular, this is a vertical view through the measurement opening 22, for example from above. The optical block of a color measuring device can be seen here, which preferably also has a quantitative fluorescence measuring device and/or a gloss measuring device.

A large number, or more precisely ten first radiation devices or light sources 2a, 2b, 2c are provided here. These are each white light LEDs, which are used to illuminate the color measurement. These light sources 2a, 2b, 2c are preferably arranged in such a way that they enable illumination of the surface, i.e. the surface to be analysed at 45°.

The reference signs 2d, 2e, 2f refer to a number of other light sources, which in particular apply colored light to the surface. This can be achieved by using colored light LEDs. However, it would also be possible and preferable for white light LEDs to be used at this point, albeit with narrow-band filtering. Monochrome LEDs, which are additionally equipped with narrow-band filters whose bandwidth is narrower than the natural bandwidth of the monochrome LEDs, can be considered as a further lighting option.

Particularly preferably, these light sources 2d, 2e, 2f emit light at different wavelengths, especially in a wavelength range of 300-660 nm.

The reference sign 4 indicates a radiation detector device and, in particular, a spectrometer. This is suitable and intended for recording light from irradiation devices 2a-2f or the light reflected from the surface (not shown).

The reference sign 12 indicates a preferably available second radiation device, which also serves to irradiate light onto the surface to be examined (not shown). This light is reflected by the surface and can thus reach the second radiation detector device 13. Preferably, the second radiation device and the second radiation detector device 13 form a gloss measuring device.

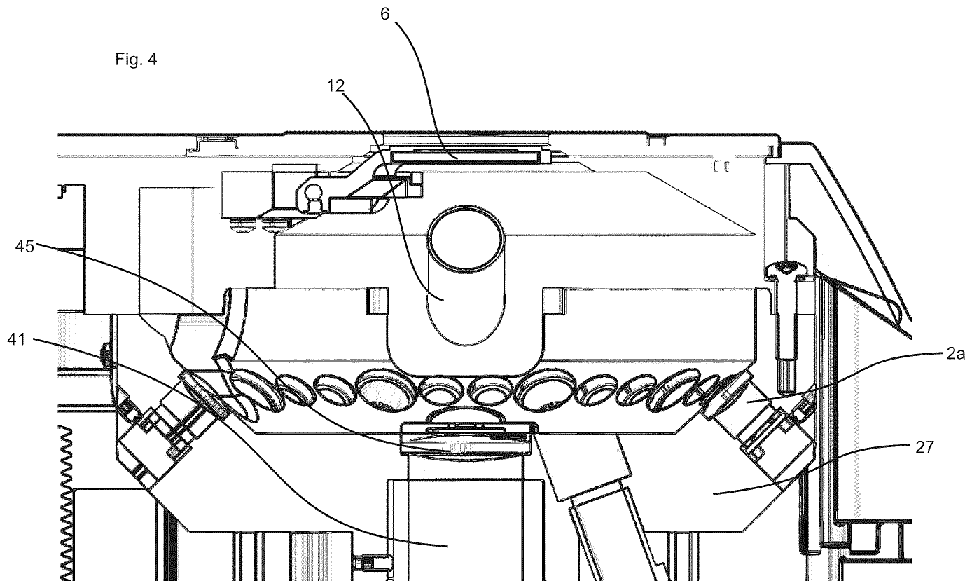

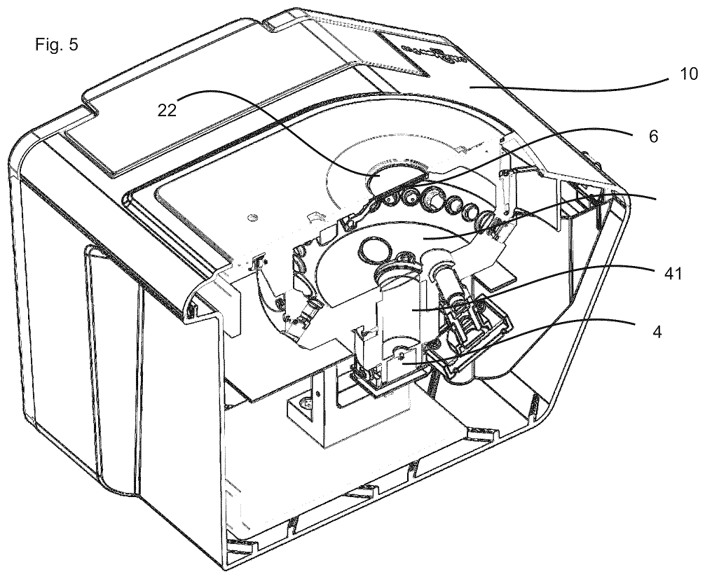

FIG. 3 shows an internal view of the apparatus described here. The first internal calibration element 6 is shown, which is arranged on a holder 62 and can be swiveled with respect to a swivel axis S into a position in which it is not located in the beam path (shown in FIG. 3) and into a position in which it is positioned against the opening 22 from the inside (FIG. 4).

The reference sign 41 indicates a tubular element through which radiation can be directed onto the radiation detector device (not shown). The reference sign 45 identifies an optical means, such as a lens, which is used to focus the radiation striking the radiation detector device.

The reference sign 52 characterizes a housing part which adjoins the opening 22. This housing part is in particular radiation-absorbing and in particular is black in color.

The reference sign 32 schematically identifies a processor device which is used, among other things, to control the apparatus 1 and also to determine or change calibration factors. The reference symbol 34 identifies a memory device which is used in particular to store calibration factors.

FIG. 4 shows an illustration of the apparatus according to the invention, whereby here the first calibration element 6, i.e. the inner standard, is swiveled into a position in which a calibration can be carried out.

The reference sign 27 indicates an optical block in which the individual radiation devices 2a2c and also 2d-2f are arranged.

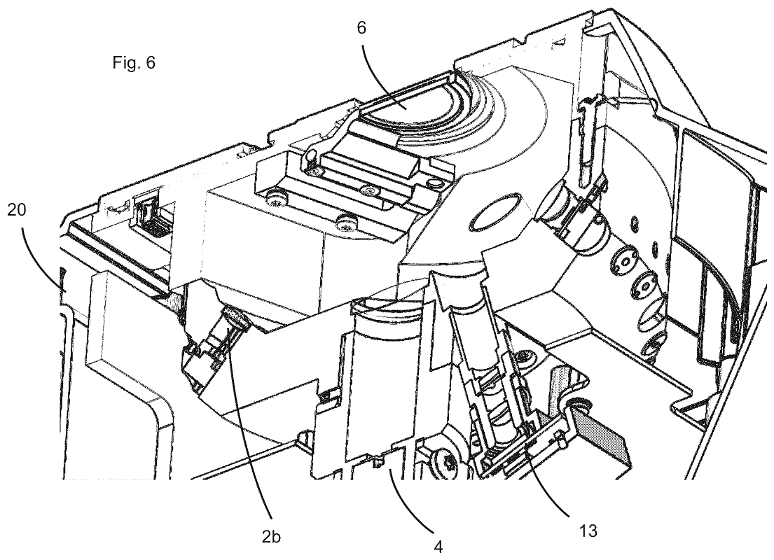

FIG. 5 shows a further illustration of the apparatus according to the invention. The radiation detector device 4 is shown here, as well as the channel 41 via which radiation is guided to the radiation detector device 4. Furthermore, the opening 22 is shown again, which is closed here and wherein the first calibration element 6 points downwards, i.e. in the direction of the radiation detector device 4.

FIG. 6 shows a bottom view of the apparatus shown in FIG. 5. A further radiation detector device 13 is shown here, which is used in particular for measuring or carrying out gloss measurements. The first radiation detector device 4 is also shown again.

The applicant reserves the right to claim all features disclosed in the application documents as being essential to the invention, provided that they are novel over the prior art individually or in combination. It should also be noted that the individual figures also describe features which may be advantageous in their own right. The person skilled in the art will immediately recognize that a particular feature described in a figure can also be advantageous even without the adoption of further features from this figure. Furthermore, the skilled person will recognize that advantages can also result from a combination of several features shown in individual figures or in different figures.

1-14. (canceled)

15. An apparatus for examining optical properties of surfaces, having a housing, having a first radiation device which is arranged within the housing and is configured for emitting radiation and in particular light onto a surface to be examined, having a first radiation detector device which is arranged within the housing and is configured for receiving radiation which has been emitted onto the surface to be examined and has been reflected and/or scattered by the surface, wherein the housing has an opening through which the first radiation device emits radiation onto the surface, wherein the apparatus comprises a first calibration element which, instead of the surface to be examined, is arranged such that radiation which has been emitted from the first radiation device onto the first calibration element and has been reflected and/or scattered by the first calibration element reaches the first radiation detector device,
wherein
the apparatus comprises a second calibration element which instead of the surface to be examined and instead of the first calibration element, arranged such that radiation which has been emitted from the first radiation device onto the second calibration element and has been reflected and/or scattered by the second calibration element reaches the first radiation detector device.

16. The apparatus according to claim 15,
wherein
one of the calibration elements is configured to be arranged within and movable within the housing into a beam path between the first radiation device and the first radiation detector device.

17. The apparatus according to claim 15,
wherein
the apparatus has a processor device which detects a first value characteristic of a first calibration measurement with the first calibration element and which is configured to detect a second value characteristic of a second calibration measurement with the second calibration element, and preferably a comparison device is provided which is configured to compare the first value and the second value.

18. The apparatus according to claim 15,
wherein
the apparatus is selected from a group of apparatuses consisting of a colour measuring device, a gloss measuring device, and an orange-peel measuring device.

19. The apparatus according to claim 15,
wherein
the apparatus has a second radiation device arranged within the housing, which is configured for emitting radiation and in particular light onto the surface to be examined.

20. The apparatus according to claim 15,
wherein
the apparatus has a gloss measuring device, this gloss measuring device having a further radiation device which is configured to irradiate radiation onto the surface at a predetermined angle of incidence, and the gloss measuring device further having a further radiation detector device which is configured to detect radiation irradiated onto the surface by the further radiation device and reflected from the surface at a predetermined angle, the angle of incidence and the further angle preferably being the same.

21. A method for examining optical properties of surfaces, wherein a radiation device arranged within a housing emits radiation and in particular light onto a surface to be examined, and a first radiation detector device arranged within the housing, which receives radiation irradiated onto the surface to be examined and reflected and/or scattered by the surface, wherein the housing has an opening through which the first radiation device emits radiation onto the surface, and wherein the apparatus has a first calibration element which, in a calibration mode, is arranged in place of the surface to be examined, in such a way that radiation which is emitted by the first radiation device onto the first calibration element and reflected and/or scattered by the first calibration element reaches the first radiation detector device,
wherein
in the calibration mode, instead of the surface to be examined and instead of the first calibration element, a second calibration element is arranged, in such a way that radiation which is emitted from the first radiation device onto the second calibration element and reflected and/or scattered by the second calibration element reaches the first radiation detector device.

22. The method according to claim 21,
wherein
a first value characteristic of a first calibration measurement with the first calibration element is recorded a second value characteristic of a second calibration measurement with the second calibration element is recorded.

23. The method according to claim 22,
wherein
the first value and the second value are compared with one another and, taking this comparison into account, an instruction or information about an error is output to a user.

24. The method according to claim 21,
wherein
a calibration value is changed taking into account at least one of the values.

25. The method according to claim 22,
wherein
in a working mode, the surface to be examined is exposed to several radiation devices.

26. The method according to claim 21,
wherein
the radiation detector device detects the radiation impinging on it as a function of wavelength.

27. The method according to claim 21,
wherein
at least one calibration is used to determine and/or take into account an ageing condition of at least one radiation device.

28. The method according to claim 21,
wherein
the surface to be examined is irradiated with light of different wavelengths and/or with white light.

29. The apparatus according to claim 15,
wherein
the apparatus has a processor device which detects a first value characteristic of a first calibration measurement with the first calibration element and which is configured to detect a second value characteristic of a second calibration measurement with the second calibration element, and preferably a comparison device is provided which is configured to compare the first value and the second value.

30. The apparatus according to claim 16,
wherein
the apparatus is selected from a group of apparatuses consisting of a colour measuring device, a gloss measuring device, and an orange-peel measuring device.

31. The apparatus according to claim 16,
wherein
the apparatus has a second radiation device arranged within the housing, which is configured for emitting radiation and in particular light onto the surface to be examined.

32. The apparatus according to claim 16,
wherein
the apparatus has a gloss measuring device, this gloss measuring device having a further radiation device which is configured to irradiate radiation onto the surface at a predetermined angle of incidence, and the gloss measuring device further having a further radiation detector device which is configured to detect radiation irradiated onto the surface by the further radiation device and reflected from the surface at a predetermined angle, the angle of incidence and the further angle preferably being the same.

33. The method according to claim 22,
wherein
a calibration value is changed taking into account at least one of the values.

34. The method according to claim 22,
wherein
in a working mode, the surface to be examined is exposed to several radiation devices.
